(19) United States
(12) Patent Application Publication
(10) Pub. No.: US 2026/0356069 A1
(43) Pub. Date: Nov. 12, 2026

(54) BOTTLE

(71) Applicant: Frugalpac Limited, Ipswich (GB)

(72) Inventors: John-Paul GROGAN, Ipswich (GB); Inês COSTA, Ipswich (GB)

(73) Assignee: Frugalpac Limited, Ipswich (GB)

(21) Appl. No.: 19/142,378

(22) PCT Filed: Dec. 22, 2023
(86) PCT No.: PCT/GB2023/053366

§ 371 Date: Jun. 23, 2025

(30) Foreign Application Priority Data
Dec. 23, 2022 (GB) 2219727.1

(51) Int. Cl. B31B 50/59; B31B 50/28; B31B 100/00

(52) U.S. Cl. CPC B31B 50/594; B31B 50/28; B31B 2100/002; B31B 2241/005

(57) ABSTRACT

A bottle has a shell comprising a flat sheet of paperboard material that has been pressed to form the three-dimensional shape of the bottle and an inner vessel for holding a liquid, the inner vessel being supported by and surrounded by the shell. The shell provides a tubular side wall of the bottle including a main body portion and a neck portion, the neck portion having a smaller diameter than the main body portion, and the neck portion comprising at least four sequentially overlapping panels of the paperboard material, at least a first side edge of all of said neck panels having an identical perimeter shape.

### FIELD OF THE INVENTION

This invention relates to bottles, and in particular to bottles having a cardboard outer shell and an inner liner, bag or pouch for containing a liquid. This invention also relates to blanks for forming the outer shell of such bottles and to methods of forming an outer shell from a blank.

### BACKGROUND TO THE INVENTION

There is a general desire and need to reduce the amount of waste that is produced and a drive to recycle as much as possible. One particular area that is receiving a lot of attention is containers for food and drink.

Traditionally wine has been stored and sold in glass bottles. The glass used is relatively heavy and typically makes up about 40% of the weight of the filled bottle of wine. This means that the transportation costs are high.

Furthermore, glass breaks relatively easily when, for example, a bottle is dropped. The bottle will typically break into sharp fragments which may cause injury to a consumer.

It is known to make a bottle having a pulp moulded cardboard outer shell and a blow moulded inner plastics lining. Although these containers have a decreased weight compared to glass bottles, they have a number of disadvantages. The shelf life of the wine within the bottles is decreased compared to glass bottles, it is difficult to apply print to the outer surface of the bottle and the unit cost of manufacture is typically significantly greater than the unit cost of a glass bottle.

It is also known to make a bottle having an outer shell formed from sheets of cardboard or paperboard that are pressed to form a 3-dimensional shape of an outer shell of a bottle. Such bottles are disclosed for example in WO 2015/150794. The shell of these bottles is formed from two sheets of cardboard that are pressed and adhered together to form a side wall of the shell. A third cardboard element is formed into a base element and adhered to the side wall.

These bottles are of significantly lower weight than glass bottles. Furthermore, as the shell can be made from recycled cardboard, they have been shown to have a lower carbon footprint compared to traditional glass bottles. These advantages have led to commercial success, and there is a need to increase the rate at which these bottles can be manufactured to meet the increasing demand.

It is, therefore, an object of the present invention to provide an improved bottle configuration that allows the shell of a bottle to be formed more easily and at a lower cost compared to prior art bottle designs.

### SUMMARY OF THE INVENTION

A first aspect of the invention provides a bottle having a shell comprising a flat sheet of paperboard material that has been pressed to form the three-dimensional shape of the bottle and an inner vessel for holding a liquid, the inner vessel being supported by and surrounded by the shell, the shell providing a tubular side wall of the bottle including a main body portion and a neck portion, the neck portion having a smaller diameter than the main body portion, and the neck portion comprising at least four sequentially overlapping panels of the paperboard material, at least a first side edge of all of said neck panels having an identical perimeter shape.

The neck portion may include at least five or at least six sequentially overlapping panels of the paperboard material.

In preferred embodiments, two diametrically opposite neck panels each include an aperture or region with which the inner vessel is engaged.

The tubular side wall of the bottle may be made from a single flat sheet of paperboard material. In some embodiments the tubular side wall of the bottle may be made from two flat sheets of paperboard material adhered together in edge regions of the flat sheets.

In preferred embodiments each of the neck panels includes a lobe portion having a convex edge. Each lobe portion overlies an edge region of a neighbouring neck panel. The lobe portions are preferably disposed in a shoulder region of the side wall of the shell between the main body portion and the neck portion.

A second aspect of the present invention provides a blank for use in manufacturing a bottle, the blank being formed of a flat sheet of paperboard, and the blank comprising:
a main body panel having two opposite side edges, a line between the side edges defining a width direction of the main body panel; and
at least two neck panels extending from the main body panel in a direction transverse to the width direction, a first side edge of all of the neck panels having an identical perimeter shape.

In preferred embodiments the blank comprises at least four, at least five or at least six neck panels extending from the main body panel. Each neck panel preferably includes a distal end edge, and each of the distal end edges are preferably parallel to each other and not perpendicular to the side edges of the main body panel.

Each of the neck panels includes first and second side edges defining a width dimension of the neck panel. In preferred embodiments a smallest width dimension of each of the neck panels is at a distal end furthest from the main body panel. In some embodiments there is a gap between opposing first and second side edges in distal portions of neighbouring neck panels.

The neck panels are preferably equidistantly spaced across the width direction of the main body panel. The blank preferably includes an even number of neck panels. In embodiments in which a single blank is used to form a side wall of the shell, this ensures that there are opposing pairs of neck panels. In embodiments in which the side wall of the shell is formed from two blanks, each blank may include an odd number of neck panels so that the shell includes an even number of neck panels in total.

In some embodiments two non-neighbouring neck panels include an aperture or weakened region. In embodiments including four neck panels, an aperture may be provided in a first neck panel and a third neck panel, with another neck panel disposed between the first and third neck panels. In embodiments including six neck panels, an aperture may be provided in a first neck panel and a fourth neck panel, with two other neck panels disposed between the first and fourth neck panels.

Each of the neck panels includes first and second side edges. Each of the neck panels comprises a proximal portion and a distal portion. In preferred embodiments the first side edge in the proximal portion of all but one of the neck panels is coincident with the second side edge in the proximal portion of a neighbouring one of the neck panels. The first side edge in the proximal portion of each of the neck panels may have a convex curvature. A proximal end of the first side edge of each neck panel may be disposed at or proximate a centreline of the respective neck panel.

A third aspect of the present invention provides a method of forming a shell of a bottle comprising:
bending a blank according to the second aspect of the invention about a longitudinal axis transverse to the width direction;
adhering a first edge region of the main body panel adjacent a first one of the side edges to a second edge region of the main body panel adjacent a second one of the side edges to form a tubular side wall of the bottle about the longitudinal axis;
pressing the neck panels of the blank in a direction towards the longitudinal axis so that a first side edge of each neck panel overlies a second side edge of a neighbouring neck panel to form a neck section of the bottle having sequentially overlapping panels; and
adhering neighbouring neck panels to each other.

In these embodiments a single blank is used to form the complete side wall of the shell.

A fourth aspect of the present invention provides a method of forming a shell of a bottle comprising:
bending a first blank according to the second aspect of the invention about a longitudinal axis transverse to the width direction;
bending a second blank according to the second aspect of the invention about a longitudinal axis transverse to the width direction;
adhering a first edge region of the main body panel of the first blank to a second edge region of the main body panel of the second blank, and adhering a first edge region of the main body panel of the second blank to a second edge region of the main body panel of the first blank to form a tubular side wall of the bottle about the longitudinal axis;
pressing the neck panels of the blanks in a direction towards the longitudinal axis so that a first side edge of each neck panel overlies a second side edge of a neighbouring neck panel to form a neck section of the bottle having sequentially overlapping panels; and
adhering neighbouring neck panels to each other.

In these embodiments two blanks are used to form the complete side wall of the shell.

In some embodiments each neck panel of the blank or of each blank includes a distal end edge, and each of the distal end edges are parallel to each other and not perpendicular to the side edges of the main body panel. In these embodiments the method preferably includes, during pressing of the neck panels, rotating each of the neck panels until the distal end edges align to form a planar upper edge of the side wall of the shell.

The method of forming a shell of a bottle may further comprise engaging a base element with an end of the tubular side wall furthest from the neck panels, and attaching or adhering the base element to the tubular side wall.

A fifth aspect of the present invention provides a method of forming a bottle comprising:
forming a shell according to the method of the third or fourth aspect of the invention; and
before pressing the neck panels, positioning an inner vessel inside an internal volume defined by the tubular side wall and then pressing the neck panels to engage the neck panels with a part of the inner vessel, the inner vessel having an internal volume for holding a liquid.

In preferred embodiments the inner vessel includes a fitment and a flexible bag, and the method preferably comprises engaging the fitment with at least two of the neck panels to prevent rotation of the fitment with respect to the shell about a longitudinal axis of the bottle. In preferred embodiments two diametrically opposite neck panels include apertures and the step of engaging the fitment with at least two of the neck panels comprises engaging a pair of lugs of the fitment with the apertures.

A sixth aspect of the invention provides a bottle having a tubular side wall formed from a blank according to the second aspect of the invention.

Preferred and/or optional features of each aspect and embodiment described above may also be used, alone or in appropriate combination, in the other aspects and embodiments also.

In the following description, a first aspect of the disclosure provides a blank for use in manufacturing a bottle, the blank being formed of a flat sheet of paperboard. The blank comprises a main body panel having two opposite side edges, a line between the side edges defining a width direction of the main body panel, and at least four neck panels extending from the main body panel in a direction transverse to the width direction, a first pair of the neck panels having a first configuration and a second pair of the neck panels having a second configuration, different to the first configuration. One of the neck panels of the second pair of neck panels is disposed between the neck panels of the first pair of neck panels.

A distance between the neck panels of the first pair of neck panels may be equal to a distance between the neck panels of the second pair of neck panels. The neck panels of the first pair of neck panels may each include an aperture or weakened region. Each of the neck panels may include first and second side edges defining a width dimension of the neck panel, and each of the neck panels may comprise a proximal portion and a distal portion, with a smallest width dimension of each of the neck panels being between the proximal portion and the distal portion. Each of the neck panels may include first and second side edges, and each of the neck panels may comprise a proximal portion and a distal portion, with the first and second side edges in the distal portion being parallel to each other. Each of the neck panels may include first and second side edges, and each of the neck panels may comprise a proximal portion and a distal portion, with at least one of the first and second side edges in the proximal portion of each of the neck panels being coincident with at least one of the first and second side edges in the proximal portion of another one of the neck panels.

Each of the neck panels may include first and second side edges extending between a distal end edge of each of the neck panels and a part of the main body panel, and ends of the side edges proximate the main body panel may define a transition boundary. The main body panel may include shoulder tabs extending beyond the transition boundary in a direction towards the distal end edges of the neck panels, with at least some of the shoulder tabs being disposed between neighbouring neck panels. Each of the shoulder tabs preferably includes a side edge that is coincident with a part of one of the side edges of one of the neck panels. The blank may further comprise a plurality of transition regions, each transition region being defined between opposing side edges in the proximal portions of neighbouring neck panels. A respective one of the shoulder tabs may fill each of the transition regions.

Each of the neck panels may include a distal end edge furthest from the main body panel, and first and second side edges, the distal end edge and the first and second side edges together defining a perimeter edge of each of the neck panels. A shape of the perimeter edge of each of the neck panels of the first pair of neck panels may be identical to a shape of the perimeter edge of each of the neck panels of the second pair of neck panels.

Each of the neck panels may include a distal end edge furthest from the main body panel, and first and second side edges, the distal end edge and the first and second side edges together defining a perimeter edge of each of the neck panels. A shape of the perimeter edge of each of the neck panels of the first pair of neck panels may be different to a shape of the perimeter edge of each of the neck panels of the second pair of neck panels.

Each neck panel may include a distal end edge, and each of the end edges may be parallel to each other and not perpendicular to the side edges of the main body panel.

In the following description, a second aspect of the disclosure provides a method of forming a container comprising bending a blank according to the first aspect of the invention about a longitudinal axis transverse to the width direction; adhering a first edge region of the main body panel adjacent a first one of the side edges to a second edge region of the main body panel adjacent a second one of the side edges to form a tubular side wall of the container about the longitudinal axis; pressing the neck panels of the blank in a direction towards the longitudinal axis so that neighbouring neck panels overlap to form a neck section of the container; and adhering neighbouring neck panels to each other.

The method may further comprise engaging a base element with an end of the tubular side wall furthest from the neck panels and adhering the base element to the tubular side wall.

The method may further comprise, before pressing the neck panels, positioning a bag inside an internal volume defined by the tubular side wall and then pressing the neck panels to engage the neck panels with the bag, the bag having an internal volume for holding a liquid.

In the following description, a third aspect of the disclosure provides a bottle having a tubular side wall formed from a blank according to the first aspect of the disclosure. Edge regions of the main body panel adjacent the side edges may overlap, and neighbouring neck panels may overlap.

### BRIEF DESCRIPTION OF THE DRAWINGS

The invention will now be further described by way of example only and with reference to the accompanying drawings, in which like reference signs are used for like features, and in which:

FIGS. 1 and 2 are perspective views of a bottle according to a first aspect of the disclosure;

FIG. 3 is a top view of the bottle of FIG. 1;

FIG. 4 is a side view of the bottle of FIG. 1;

FIG. 5 is a cross-sectional view along the line V-V of FIG. 3;

FIG. 6 is a cross-sectional view along the line VI-VI of FIG. 3;

FIG. 7 is a cross-sectional view along the line VII-VII of FIG. 4;

FIG. 8 is a cross-sectional view along the line VIII-VIII of FIG. 4;

FIG. 9 is a cross-sectional view along the line IX-IX of FIG. 4;

FIG. 10 is a cross-sectional view along the line X-X of FIG. 4;

FIG. 11 shows a blank used to form a shell of the bottle of FIG. 1;

FIGS. 12 and 13 are perspective views of a bottle according to an embodiment of the present invention;

FIG. 14 is a top view of the bottle of FIG. 12;

FIG. 15 is a side view of the bottle of FIG. 12;

FIG. 16 is a cross-sectional view along the line XVI-XVI of FIG. 14;

FIG. 17 is a cross-sectional view along the line XVII-XVII of FIG. 15;

FIG. 18 is a cross-sectional view along the line XVIII-XVIII of FIG. 15;

FIG. 19 is a cross-sectional view along the line XIX-XIX of FIG. 15;

FIG. 20 shows a blank used to form a shell of the bottle of FIG. 12;

FIGS. 21 and 22 are perspective views of a bottle according to an aspect of the disclosure;

FIG. 23 is a top view of the bottle of FIG. 21;

FIG. 24 is a cross-sectional view along the line XXIV-XXIV of FIG. 23;

FIG. 25 is a first side view of the bottle of FIG. 21;

FIG. 26 is a second side view of the bottle of FIG. 21 in a direction perpendicular to the side view

FIG. 27 is a cross-sectional view along the line XXVII-XXVII of FIG. 25;

FIG. 28 is a cross-sectional view along the line XXVIII-XXVIII of FIG. 25;

FIG. 29 is a cross-sectional view along the line XXIX-XXIX of FIG. 25;

FIG. 30 is a cross-sectional view along the line XXX-XXX of FIG. 25;

FIG. 31 is a cross-sectional view along the line XXXI-XXXI of FIG. 25; and

FIG. 32 shows a blank used to form a shell of the bottle of FIG. 21.

### DESCRIPTION OF THE PREFERRED EMBODIMENTS

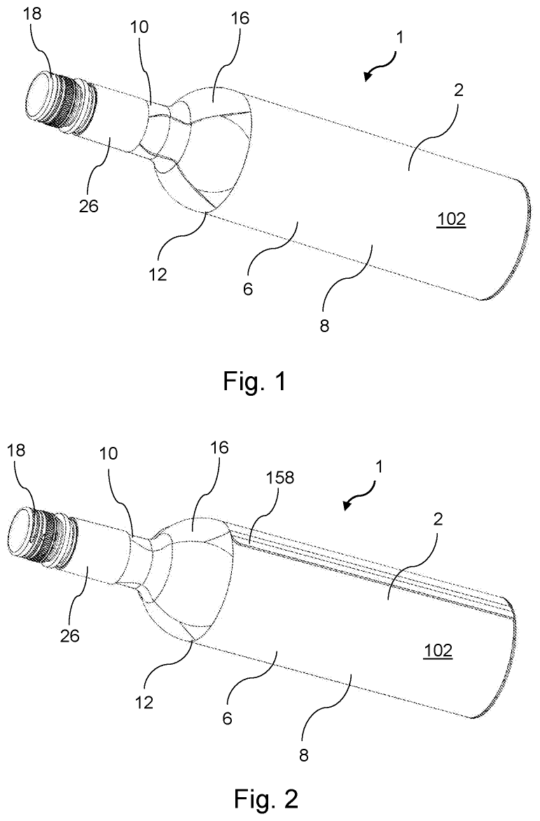

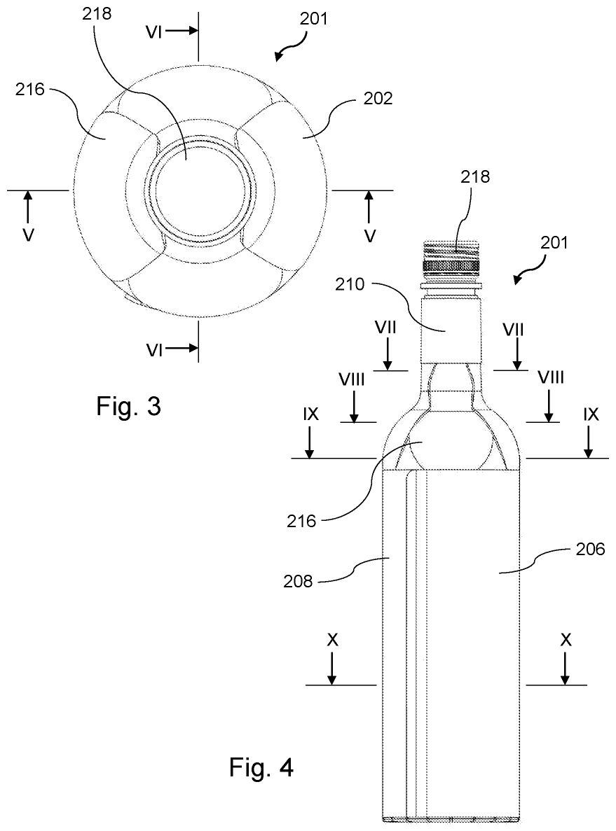

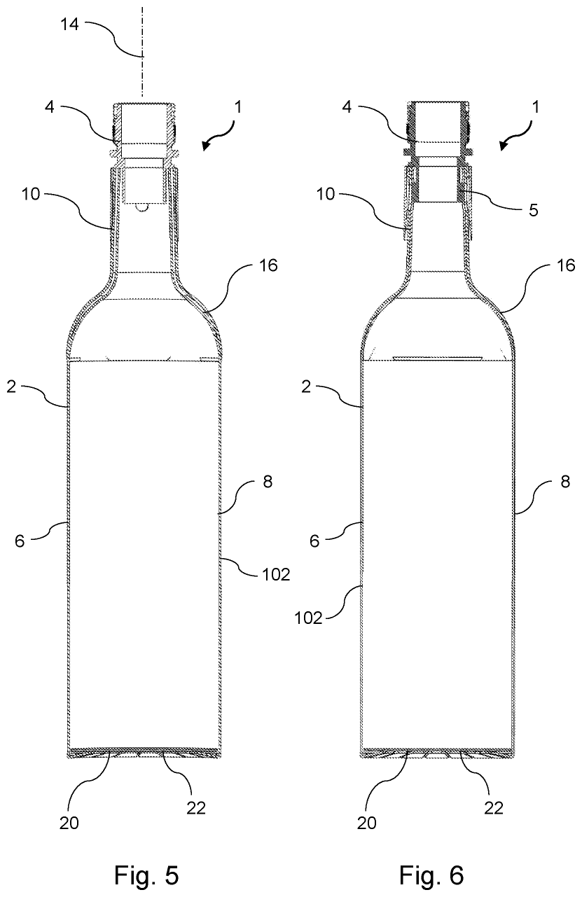

FIGS. 1 to 10 illustrate a container 1 in the form of a bottle 1. The bottle 1 comprises an outer shell 2 made of a paperboard or cardboard material and an inner vessel for holding a liquid. The inner vessel preferably comprises a bag (not shown) attached to a fitment 4. The bag is preferably adhered or welded to an end portion of the fitment 4 so that the fitment 4 forms a neck portion of the inner vessel and defines an opening of the vessel. The bag and fitment 4 are, preferably, each made of a liquid impermeable material. The bag and fitment 4 may be made of a plastics material. The inner vessel is supported within the shell 2. The shell 2 preferably completely surrounds the bag forming the inner vessel. The inner vessel is preferably supported within the shell 2 by the fitment 4.

In this example the shell 2 of the bottle 1 comprises a side wall 6 which is generally cylindrical. The side wall 6 comprises an elongate, tubular main body portion 8 having a first, larger diameter, and an elongate, tubular neck portion 10 having a second, smaller diameter. The neck portion 10 extends from a first end 12 of the main body portion 8, and in this example a longitudinal axis 14 of the neck portion 10 is coaxial with a longitudinal axis 14 of the main body portion 8. This axis 14 forms a longitudinal axis of the complete bottle 1. A tapered, shoulder portion 16 of the bottle 1 extends between the neck portion 10 and the main body portion 8.

The fitment 4 is engaged with the neck portion 10 of the side wall 6 of the shell 2 such that the bag is suspended from the fitment 4 and extends into an internal volume defined and surrounded by the main body portion 8 of the side wall 6. In this embodiment the fitment 4 includes a pair of lugs 5 that protrude in a radially outward direction. The lugs 5 engage with the neck portion 10 of the shell 2, as described further below.

It will be appreciated that the bag is preferably made of a flexible material. When the bag is filled with a liquid the bag may conform to at least part of an internal shape of the shell 2. An upper end of the fitment 4, furthest from the bag, protrudes from an end of the neck portion 10 of the shell 2. The upper end of the fitment 4 may include a male screw thread on an external surface for receiving and engaging with a female screw thread of a bottle top or cap 18.

The shell 2 may also include a base element 20. In this example the base element 20 comprises a base plate 22 engaged with the tubular main body portion 8 of the side wall 6 proximate a lower end of the side wall 6 furthest from the neck portion 10.

The side wall 6 of the shell 2 is preferably made from a flat sheet of paperboard that has been pressed to form the required three-dimensional shape of the bottle 1. In preferred embodiments the sheet of paperboard is multi-ply including a first surface layer formed from a paperboard material providing a good surface for printing. This first surface layer may comprise bleached fibres, for example. When the sheet of paperboard is pressed to form the side wall 6, the orientation of the paperboard is preferably such that this first surface layer forms an external surface 24 of the shell 2. Because the side wall 6 is formed from an initially flat sheet of paperboard, the first, outer surface of the paperboard may be easily printed before the side wall 6 is formed. This enables designs and branding to be applied to the container 1 before the shell 2 is formed, thereby decreasing the complexity and costs of applying designs to the container 1.

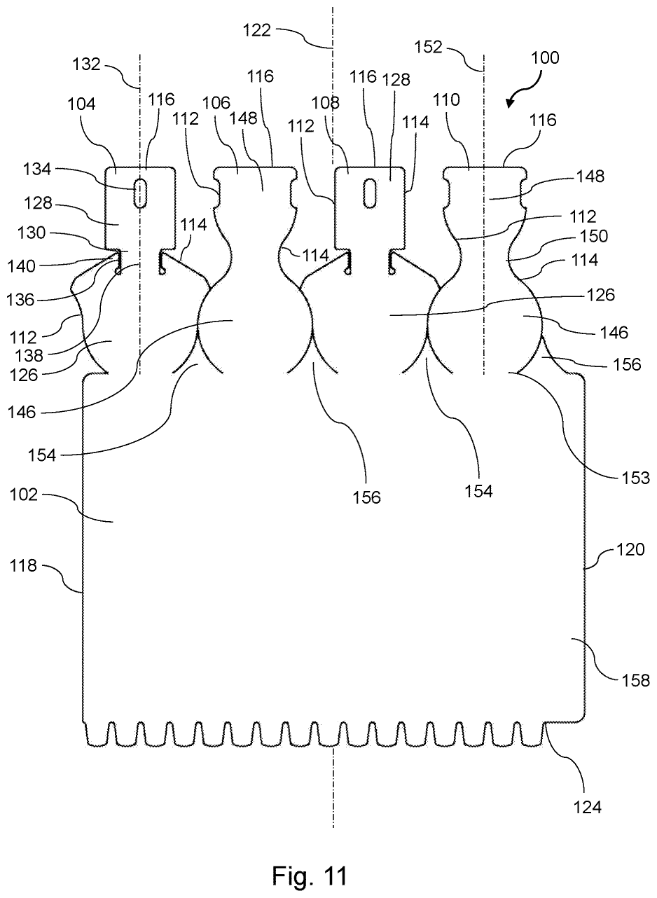

FIG. 11 illustrates a blank 100 used to form the side wall 6 of the shell 2 of the bottle 1 of this example.

The blank 100 includes a substantially rectangular main body panel 102 and four neck panels 104, 106, 108, 110. The four neck panels 104, 106, 108, 110 extend from a first end of the main body panel 102. Each of the neck panels 104, 106, 108, 110 has first and second side edges 112, 114, and a distal end edge 116 furthest from the main body panel 102. Each of the neck panels 104, 106, 108, 110 extends from the main body panel 102 in a longitudinal direction. Side edges 118, 120 of the main body panel 102 are parallel to each other. A line extending between the side edges 118, 120 defines a width or lateral direction of the main body panel 102, transverse to the longitudinal direction. A longitudinal axis 122 of the blank 100 extends in the longitudinal direction midway between the side edges 118, 120. The main body panel 102 also has a base end edge 124 furthest from the neck panels 104, 106, 108, 110 and extending between the side edges 118, 120.

In this example the blank 100 includes a first pair of neck panels 104, 108 and a second pair of neck panels 106, 110. The neck panels of the first pair of neck panels 104, 108 are identical in shape and configuration. Similarly, the neck panels of the second pair of neck panels 106, 110 are identical in shape and configuration. The neck panels of the first pair of neck panels 104, 108, however, have a different shape and configuration to that of the neck panels of the second pair of neck panels 106, 110.

Each of the neck panels of the first pair of neck panels 104, 108 comprises a proximal portion 126 nearest the main body panel 102, and a distal portion 128 furthest from the main body panel 102 and adjacent the distal end edge 116 of the neck panel 104, 108. A smallest lateral or width dimension of each of the neck panels of the first pair of neck panels 104, 108 is disposed between the proximal portion 126 and the distal portion 128. This smallest lateral dimension defines a transition region 130 of each of the neck panels 104, 108 between the proximal portion 126 and the distal portion 128. In this way, each of the neck panels of the first pair of neck panels 104, 108 has a generally hourglass shape.

In the distal portion 128 of each of the neck panels of the first pair of neck panels 104, 108 the side edges 112, 114 are parallel to each other and extend generally in the longitudinal direction. At the transition region 130, side edges extend laterally towards a centreline 132 of the neck panel 104, 108. In this way, the distal portion 128 of each of the neck panels 104, 108 has a generally rectangular shape. The distal portion 128 of each of the neck panels of the first pair of neck panels 104, 108 further includes an aperture 134. In this example the aperture 134 is disposed on the centreline 132, midway between side edges 112, 114 of the distal portion 128. A pair of longitudinally extending cut lines 136 extend from the side edges in the transition region 130 into the proximal portion 126. A stem region 138 is defined between the cut lines 136, and a pair of tabs 140 are formed laterally outwardly of the cut lines 136. In this example the proximal portion 126 of each of the neck panels of the first pair of neck panels 104, 108 is generally shield-shaped. A maximum width or lateral dimension of the proximal portion 126 is disposed closer to the transition region 130 than to the main body panel 102, and a width of the proximal portion 126 generally decreases in a direction towards the main body panel 102.

Each of the neck panels of the second pair of neck panels 106, 110 comprises a proximal portion 146 nearest the main body panel 102, and a distal portion 148 furthest from the main body panel 102 and adjacent the distal end edge 116 of the neck panel 106, 110. A smallest lateral or width dimension of each of the neck panels of the second pair of neck panels 106, 110 is disposed between the proximal portion 146 and the distal portion 148. This smallest lateral dimension defines a transition region 150 of each of the neck panels 106, 110 between the proximal portion 146 and the distal portion 148. In this way, each of the neck panels of the second pair of neck panels 106, 110 has a generally hourglass shape. In this example, side edges 112, 114 in the transition region 150 are curved and are generally concave. Side edges 112, 114 in the proximal portion 146 are curved and are generally convex.

The neck panels 104, 106, 108, 110 are arranged such that a first one of the neck panels 106 of the second pair of neck panels 106, 110 is disposed between the neck panels of the first pair of neck panels 104, 108. Similarly, a second one of the neck panels 108 of the first pair of neck panels 104, 108 is disposed between the neck panels of the second pair of neck panels 106, 110. In this way the first and second pairs of neck panels 104, 108, 106, 110 may be considered to be interspaced.

In this example, the dimensions of the neck panels 104, 106, 108, 110 are such that a distance between the centrelines 132 of the neck panels of the first pair of neck panels 104, 108 is equal to a distance between centrelines 152 of the neck panels of the second pair of neck panels 106, 110.

The lateral dimensions of the distal portions 128, 148 of the first and second pairs of neck panels 104, 108, 106, 110 are such that there is a gap between opposing side edges 112, 114 of neighbouring neck panels 104, 106, 108, 110.

A part of the first side edge 112 of each of the neck panels of the second pair of neck panels 106, 110 in the proximal portion 146 is coincident with a part of the second side edge 114 of each of the neck panels of the first pair of neck panels 104, 108 in the proximal portion 126. These coincident parts of the first and second side edges 112, 114 may be formed by a single cut line. Between the coincident parts of the first and second side edges 112, 114 and proximal ends of the side edges 112, 114 at or proximate the main body panel 102, the contiguous first and second side edges 112, 114 of neighbouring neck panels 104, 108, 106, 110 diverge in a direction towards the proximal ends of the side edges 112, 114.

The proximal ends of the side edges 112, 114 define a transition boundary 153. In this example, the proximal ends of the side edges 112, 114 of all of the neck panels 104, 106, 108, 110 are aligned such that the transition boundary 153 is linear. A transition region 154 is defined between the diverging contiguous first and second side edges 112, 114 of neighbouring neck panels 104, 108, 106, 110 and the transition boundary 153. In this example, the transition regions 154 have a generally triangular shape.

In this example the main body panel 102 includes shoulder tabs 156 that extend beyond the transition boundary 153 in a direction towards the distal end edges 116 of the neck panels 104, 106, 108, 110. The main body panel 102 includes four shoulder tabs 156. Three of the shoulder tabs 156 are disposed in the transition regions 154 between neighbouring neck panels 104, 108, 106, 110. In this example, the shoulder tabs 156 fill the full extent of the transition regions 154. Accordingly, side edges of these shoulder tabs 156 are coincident with the divergent parts of the first and second side edges 112, 114 of the neck panels 104, 108, 106, 110. A fourth one of the shoulder tabs 156 is disposed in a lateral direction between a second one of the neck panels 110 of the second pair of neck panels 106, 110 and a second side edge 120 of the main body panel 102. The fourth shoulder tab 156 has the same shape as the other three shoulder tabs 156, and one of the side edges of the fourth shoulder tab 156 is coincident with a part of the second side edge 114 of the second one of the neck panels 110 of the second pair of neck panels 106, 110. Each of the shoulder tabs 156 of this example is generally triangular.

An edge region 158 of the main body panel 102 adjacent the second side edge 120 provides a tab region 158. The tab region 158 preferably extends in the longitudinal direction along the full length of the side edge 120 of the main body panel 102. The tab region 158 extends in the lateral direction further than the maximum lateral extent of the neck panels 104, 106, 108, 110 and shoulder tabs 156.

Referring again to FIGS. 1 to 10, the blank 100 is pressed to form the three-dimensional shape of the side wall 6 of the shell 2 of the bottle 1. The main body panel 102 is curved or bent to form the tubular main body portion 8 of the side wall 6. In this example the main body panel 102 is curved around so that the tab region 158 overlaps an edge region of the main body panel 102 adjacent the other side edge 118. The tab region 158 is then adhered to the edge region to retain the tubular shape. In this example a cross-sectional shape of the main body portion 8 of the side wall 6 in a plane perpendicular to the longitudinal axis 14 is generally circular, as shown in FIG. 10.

With the blank 100 curved to the shape of the tubular main body portion 8 the neck panels of the first pair of neck panels 104, 108 are disposed diametrically opposite each other. Similarly, the neck panels of the second pair of neck panels 106, 110 are disposed diametrically opposite each other. The neck panels 104, 106, 108, 110 are then pressed around a suitable former to form the shoulder portion 16 and the tubular neck portion 10 of the shell 2. In particular, in this example, the proximal portions 126, 146 of the neck panels 104, 108, 106, 110 are shaped to form the shoulder portion 16 and the distal portions 128, 148 of the neck panels 104, 108, 106, 110 are shaped to form the neck portion 10 of the shell 2. The transition region 130, 150 of each of the neck panels 104, 108, 106, 110 is shaped to provide a transition region of the shell 2 between the shoulder portion 16 and the neck portion 10.

In a preferred method of forming the shell 2 of the bottle 1, the neck panels of the second pair of neck panels 106, 110 are pressed in a direction towards the longitudinal axis 14. The distal portions 148 of the neck panels 106, 110 are each formed into a part-cylindrical shape having a longitudinal axis aligned with the longitudinal axis of the shell 2 to form the neck portion 10 of the shell 2. The proximal portions 146 of the neck panels 106, 110 are each curved to form a part of the shoulder portion 16.

The neck panels of the first pair of neck panels 104, 108 are then pressed in a direction towards the longitudinal axis 14. The distal portions 128 of the neck panels 104, 108 are each formed into a part-cylindrical shape having a longitudinal axis aligned with the longitudinal axis of the shell 2 to form the neck portion 10 of the shell 2. In this example, as the distal portions 128 of the neck panels 104, 108 are formed, the lugs 5 of the fitment 4 protrude through the apertures 134. It will be appreciated that the engagement of the lugs 5 in the apertures 134 helps to suspend the bag within the shell 2 and prevents the fitment 4 turning within the neck portion 10 of the shell 2. This prevents the fitment 4 turning when a user removes the screw cap 18 from the fitment 4 or secures the screw cap 18 onto the fitment 4.

The proximal portions 126 of the neck panels 104, 108 are each curved to form a part of the shoulder portion 16. In this embodiment each part of the shoulder portion 16 formed by a proximal portion 126, 146 of the neck panels 104, 106, 108, 110 has a double curvature. In particular, each part of the shoulder portion 16 has two planes of principle curvature substantially perpendicular to each other. A first axis of curvature is substantially vertical and a second axis of curvature is substantially horizontal (relative to the longitudinal axis of the bottle 1). In this way, each part of the shoulder portion 16 has a quarter-dome shape or truncated quarter-dome shape.

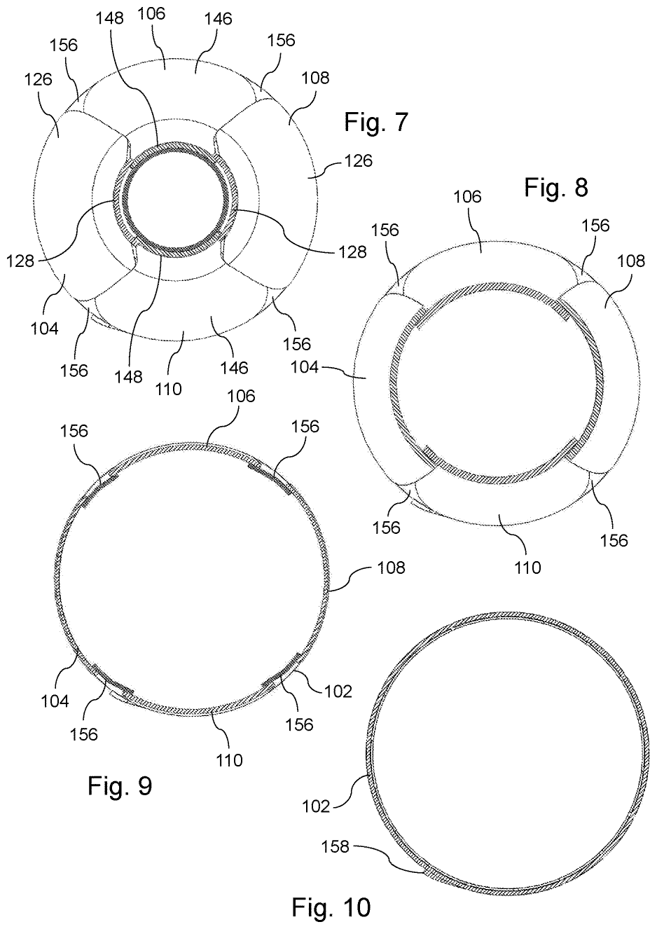

Edge regions of the distal portions 128 of the neck panels 104, 108, adjacent the side edges 112, 114, overlap equivalent edge regions of the distal portions 148 of the neck panels 106, 110. These overlapping edge regions are adhered together to form the complete tubular neck portion 10 of the shell 2, as illustrated in FIGS. 7 and 8.

As the proximal portions 126, 146 of the neck panels 104, 108, 106, 110 are shaped to form the shoulder portion 16 of the shell 2, the shoulder tabs 156 are pressed inwardly between the proximal portions 126, 146. Edge regions of each of the proximal portions 126, 146 overlap edge regions of the shoulder tabs 156, as shown in FIG. 9. The provision of these shoulder tabs 156 therefore allows a smoothly curving outer surface of the shoulder portion 16 of the shell 2 to be formed, and avoids the formation of large creases or folds in the proximal portions 126, 146 of the neck panels 104, 108, 106, 110.

Once the complete side wall 6 of the shell 2 has been formed, the base element 20 may be inserted into a lower end of the tubular side wall 6 and adhered to the side wall 6. Further, a label or strip of tape 26 may be wrapped around the neck portion 10 of the shell 2 to cover the overlapping edge regions of the distal portions 128, 148 of the neck panels 104, 106, 108, 110 and to ensure that the neck portion 10 of the shell is secured around the lower end of the fitment 4. In particular, the label or strip of tape 26 may cover the lugs 5 of the fitment 4 that protrude through the apertures 134 in the neck panels of the first pair of neck panels 104, 108.

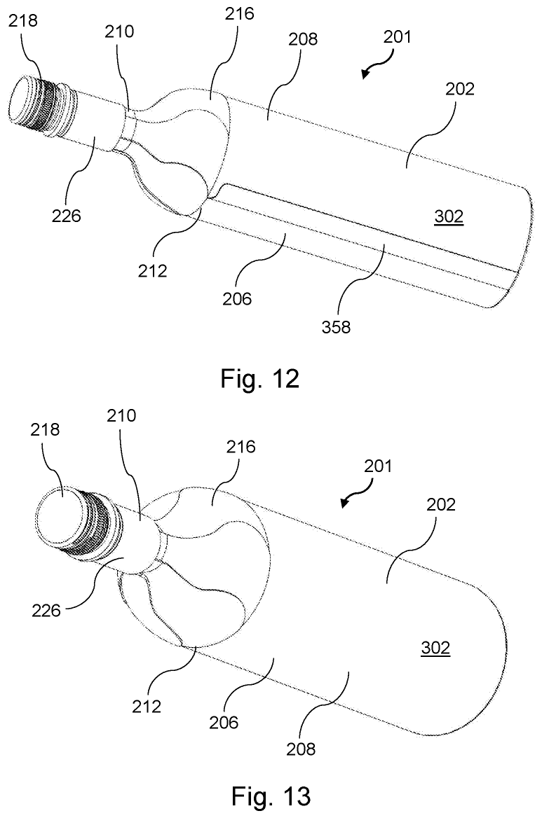

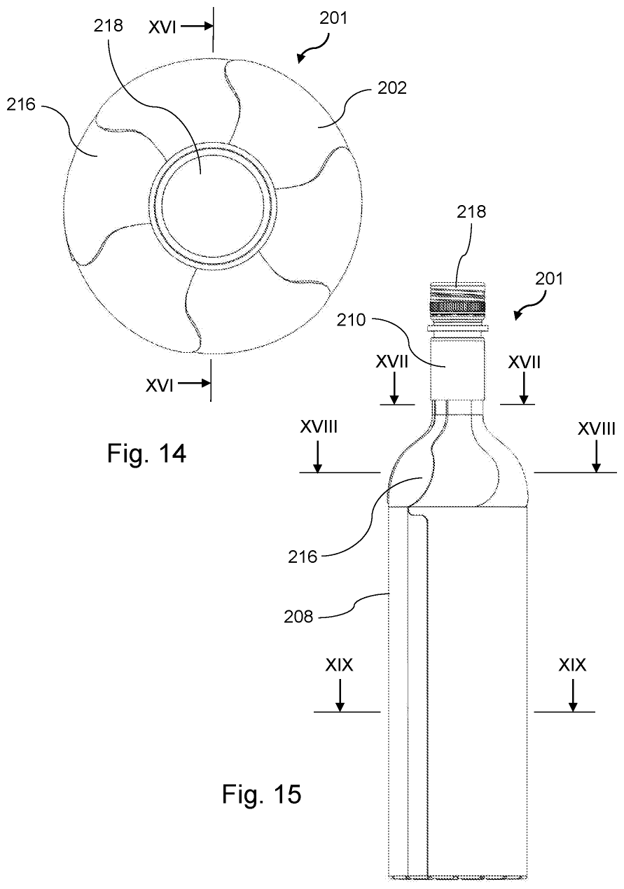

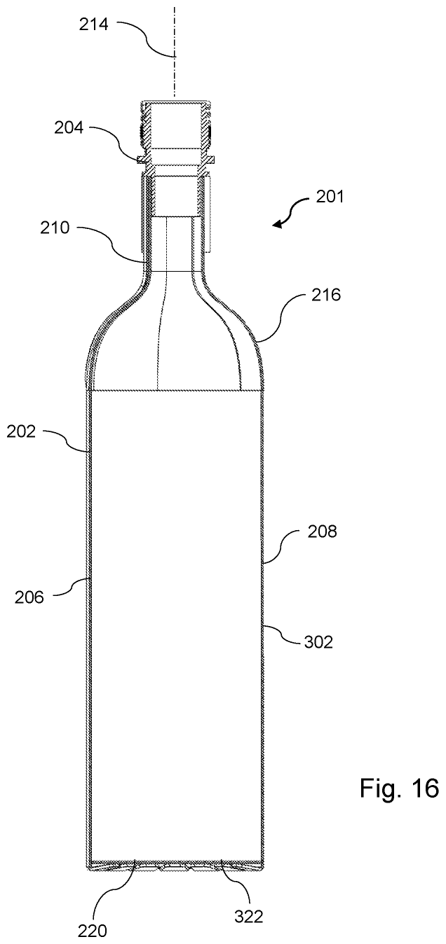

FIGS. 12 to 19 illustrate a container 201 in the form of a bottle 201 according to a preferred embodiment of the present invention.

The bottle 201 comprises an outer shell 202 made of a paperboard or cardboard material and an inner vessel for holding a liquid. The inner vessel preferably comprises a bag (not shown) attached to a fitment 204. The bag is preferably adhered or welded to a lower end portion of the fitment 204 so that the fitment 204 forms a neck portion of the inner vessel and defines an opening of the vessel. The bag and fitment 204 are, preferably, each made of a liquid impermeable material. The bag and fitment 204 may be made of a plastics material. The inner vessel is supported within the shell 202.

In preferred embodiments the inner vessel is supported within the shell 202 by the fitment 204. Preferably the bag is completely surrounded by the shell 202 so that the bag is fully concealed. A part of the fitment may extend from the shell 202.

In this embodiment the shell 202 of the bottle 201 comprises a side wall 206 which is generally cylindrical. The side wall 206 comprises an elongate, tubular main body portion 208 having a first, larger diameter, and an elongate, tubular neck portion 210 having a second, smaller diameter. The neck portion 210 extends from a first end 212 of the main body portion 208, and in this example a longitudinal axis 214 of the neck portion 210 is coaxial with a longitudinal axis 214 of the main body portion 208. This axis 214 forms a longitudinal axis of the complete bottle 201. A tapered, shoulder portion 216 of the bottle 201 extends between the neck portion 210 and the main body portion 208.

The fitment 204 is engaged with the neck portion 210 of the side wall 206 of the shell 202 such that the bag is suspended from the fitment 204 and extends into an internal volume defined and surrounded by the main body portion 208 of the side wall 206. In this embodiment the fitment 204 includes a pair of lugs 205 that protrude in a radially outward direction. The lugs 205 engage with the neck portion 210 of the shell 202, as described further below.

It will be appreciated that the bag is preferably made of a flexible material. When the bag is filled with a liquid the bag may conform to at least part of an internal shape of the shell 202. An upper end of the fitment 204, furthest from the bag, protrudes from an end of the neck portion 210 of the shell 202. The upper end of the fitment 204 may include a male screw thread on an external surface for receiving and engaging with a female screw thread of a bottle top or cap 218.

The shell 202 may also include a base element 220. In this example the base element 220 comprises a base plate 222 engaged with the tubular main body portion 208 of the side wall 206 proximate a lower end of the side wall 206 furthest from the neck portion 210.

The side wall 206 of the shell 202 is preferably made from a flat sheet of paperboard that has been pressed to form the required three-dimensional shape of the bottle 201. In preferred embodiments the sheet of paperboard is multi-ply including a first surface layer formed from a paperboard material providing a good surface for printing. This first surface layer may comprise bleached fibres, for example. When the sheet of paperboard is pressed to form the side wall 206, the orientation of the paperboard is preferably such that this first surface layer forms an external surface 224 of the shell 202. Because the side wall 206 is formed from an initially flat sheet of paperboard, the first, outer surface of the paperboard may be easily printed before the side wall 206 is formed. This enables designs and branding to be applied to the container 201 before the shell 202 is formed, thereby decreasing the complexity and costs of applying designs to the container 201.

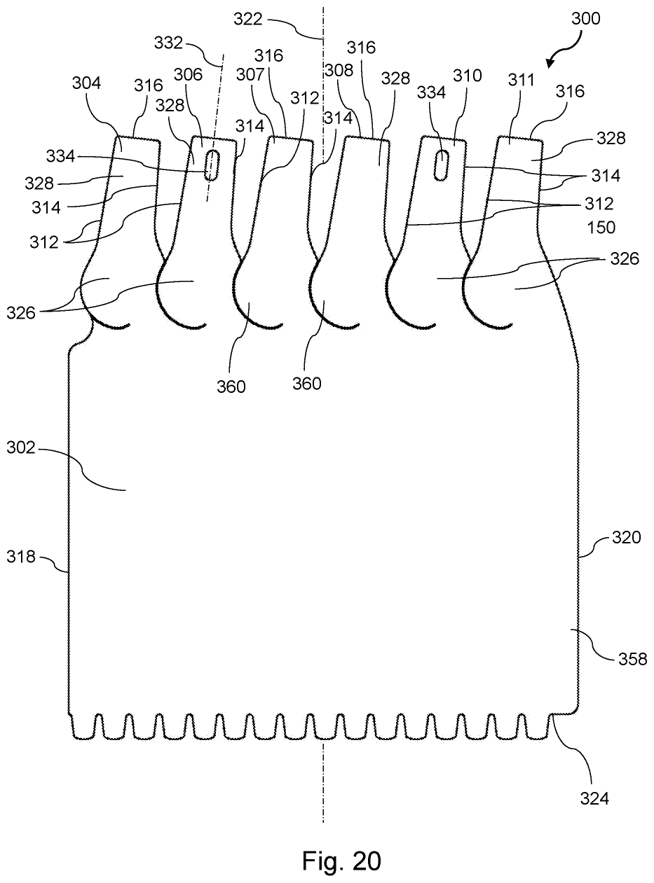

FIG. 20 illustrates a blank 300 used to form the side wall 206 of the shell 202 of the bottle 201 of this embodiment.

In this embodiment the blank 300 is designed so that a single blank 300 may be used to form the complete side wall 206 of the shell 202.

The blank 300 includes a substantially rectangular main body panel 302 and six neck panels 304, 306, 307, 308, 310, 311. The six neck panels 304, 306, 307, 308, 310, 311 extend from a first end of the main body panel 302. Each of the neck panels 304, 306, 307, 308, 310, 311 has first and second side edges 312, 314, and a distal end edge 316 furthest from the main body panel 302. Each of the neck panels 304, 306, 307, 308, 310, 311 extends from the main body panel 302 in a longitudinal direction.

In this embodiment side edges 318, 320 of the main body panel 302 are parallel to each other. A line extending between the side edges 318, 320 defines a width or lateral direction of the main body panel 302, transverse to the longitudinal direction. A longitudinal axis 322 of the blank 300 extends in the longitudinal direction midway between the side edges 318, 320. The main body panel 302 also has a base end edge 324 furthest from the neck panels 304, 306, 307, 308, 310, 311 and extending between the side edges 318, 320.

In this embodiment the blank 300 includes a first pair of neck panels 304, 308, a second pair of neck panels 306, 310, and a third pair of neck panels 307, 311. The neck panels of the first pair of neck panels 304, 308 are identical in shape and configuration. Similarly, the neck panels of the second pair of neck panels 306, 310 are identical in shape and configuration, and the neck panels of the third pair of neck panels 307, 311 are identical in shape and configuration. The neck panels of the second pair of neck panels 306, 310, however, have a different configuration to that of the neck panels of each of the first pair of neck panels 304, 308 and third pair of neck panels 307, 311. Furthermore, in this embodiment the shape and configuration of the second pair of neck panels 306, 310 is identical to the shape and configuration of the third pair of neck panels 307, 311.

The neck panels 304, 306, 307, 308, 310, 311 are arranged such that a first one of the neck panels 306 of the second pair of neck panels 306, 310 and a first one of the neck panels 307 of the third pair of neck panels 307, 311 are disposed between the neck panels of the first pair of neck panels 304, 308. Similarly, a second one of the neck panels 308 of the first pair of neck panels 304, 308 and a second one of the neck panels 310 of the second pair of neck panels 306, 310 are disposed between the neck panels of the third pair of neck panels 307, 311. Finally, a second one of the neck panels 308 of the first pair of neck panels 304, 308 and a first one of the neck panels 307 of the third pair of neck panels 307, 311 are disposed between the neck panels of the second pair of neck panels 306, 310. In this way the first, second and third pairs of neck panels 304, 308, 306, 310, 307, 311 may be considered to be interspaced.

In this embodiment, a perimeter shape of all but one of the neck panels 304, 306, 307, 308, 310 is identical. Each of the neck panels 304, 306, 307, 308, 310, 311 comprises a proximal portion 326 nearest the main body panel 302, and a distal portion 328 furthest from the main body panel 302 and adjacent the distal end edge 316 of the neck panel 304, 308. It is to be noted that a perimeter edge of the proximal portion 326 of the neck panel 311 adjacent one of the side edges 320 of the main body panel 302 is different to the perimeter edge of the proximal portion 326 of the other neck panels 304, 306, 307, 308, 310. The perimeter of the second side edge 314 of the proximal portion 326 of the neck panel 311 is shaped to join with a tab region 358 at the second side edge 320 of the main body portion 302. A perimeter shape of the first side edge 312 of all of the neck panels 304, 306, 307, 308, 310, 311 is, however, identical.

The distal end edges 316 of the neck panels 304, 306, 307, 308, 310, 311 of this embodiment are parallel to each other, but are not perpendicular to the side edges 318, 320 of the main body panel 302.

The side edges 312, 314 of each of the neck panels 304, 306, 307, 308, 310, 311 in the distal portion 328 diverge in a direction from the distal end edge 316 towards the main body panel 302. An angle of divergence in the distal portion 328, measured relative to a centreline of the distal portion 328, is preferably less than 5°, and more preferably less than 2°. Accordingly, the distal portion 328 of each of the neck panels 304, 306, 307, 308, 310, 311 is substantially rectangular. In other embodiments the angle of divergence in the distal portion, measured relative to a centreline of the distal portion, may be less than 25°, and more preferably less than 20°.

A spacing between the neck panels 304, 306, 307, 308, 310, 311 and dimensions of the distal portion 328 of each of the neck panels 304, 306, 307, 308, 310, 311 means that there is a gap between opposing side edges 312, 314 of the distal portions 328 of neighbouring neck panels 304, 306, 307, 308, 310, 311.

In the proximal portion 326 of each of the neck panels 304, 306, 307, 308, 310, 311 the side edges 312, 314 diverge further in a direction towards the main body panel 302. An angle of divergence in the proximal portion 326, in a region adjacent the distal portion 328 and measured relative to a centreline of the proximal portion 326, is preferably greater than 5°, and more preferably between 5° and 45°.

The first side edge 312 of each of the neck panels 304, 306, 307, 308, 310, 311 terminates at a proximal end at or proximate the main body panel 302. A part of the first side edge 312 adjacent the proximal end has a convex curvature. The curvature of the proximal part of the first side edge 312 is such that the proximal end of the first side edge 312 is disposed close to or on the centreline of the proximal portion 326.

The second side edge 314 of each of the neck panels 304, 306, 307, 308, 310 intersects the first side edge 312 of the neighbouring neck panel 306, 307, 308, 310, 311. In this embodiment the second side edge 314 intersects the first side edge 312 in the region adjacent the distal portion 328. In this way, the convex curved portion of the first side edge 312 forms an edge of a lobe portion 360 of each of the neck panels 304, 306, 307, 308, 310, 311.

In other embodiments a lobe portion 360 of the neck panels 304, 306, 307, 308, 310, 311 may be formed by a convex portion formed from a plurality of straight edge regions. For example, the lobe portion 360 may have a perimeter edge in the shape of half a hexagon, half an octagon, or similar.

A lateral extent of the side edges 312, 314 of each of the neck panels 304, 306, 307, 308, 310, 311 may be considered to be a distance of the side edge 312, 314 from a centreline 332 of the neck panel 304, 306, 307, 308, 310, 311 in a direction perpendicular to the centreline 332. In preferred embodiments, a lateral extent of the first side edge 312 in the proximal portion 326 (i.e. a lobe portion 360) of one neck panel 304, 306, 307, 308, 310, 311 does not extend further than a lateral extent of the adjacent second side edge 314 of the distal portion 328 of the neighbouring neck panel 304, 306, 307, 308, 310, 311.

The distal portion 328 of each of the neck panels of the second pair of neck panels 306, 310 includes an aperture 334. In this example the aperture 334 is disposed on the centreline 332, midway between side edges 312, 314 of the distal portion 328. None of the neck panels of the first pair of neck panels 304, 308 or the third pair of neck panels 307, 311 includes an aperture.

An edge region 358 of the main body panel 302 adjacent the second side edge 320 provides a tab region 358. The tab region 358 preferably extends in the longitudinal direction along the full length of the side edge 320 of the main body panel 302. The tab region 358 extends in the lateral direction further than the maximum lateral extent of the first neck panel 304.

Referring again to FIGS. 12 to 19, the blank 300 is pressed to form the three-dimensional shape of the side wall 206 of the shell 202 of the bottle 201.

The main body panel 302 is curved or bent to form the tubular main body portion 208 of the side wall 206. In this embodiment the main body panel 302 is curved around so that the tab region 358 overlaps an edge region of the main body panel 302 adjacent the other side edge 318. The tab region 358 is then adhered to the edge region to retain the tubular shape. In this embodiment a cross-sectional shape of the main body portion 308 of the side wall 306 in a plane perpendicular to the longitudinal axis 214 is generally circular, as shown in FIG. 19.

With the blank 300 curved to the shape of the tubular main body portion 208 the neck panels of the first pair of neck panels 304, 308 are disposed diametrically opposite each other. Similarly, the neck panels of the second pair of neck panels 306, 310 are disposed diametrically opposite each other, and the neck panels of the third pair of neck panels 307, 311 are disposed diametrically opposite each other.

The neck panels 304, 306, 307, 308, 310, 311 are then pressed around a suitable former to form the shoulder portion 216 and the tubular neck portion 210 of the shell 202. In particular, in this embodiment, the proximal portions 326 of the neck panels 304, 306, 307, 308, 310, 311 are shaped to form the shoulder portion 216 and the distal portions 328 of the neck panels 304, 306, 307, 308, 310, 311 are shaped to form the neck portion 210 of the shell 202.

In a preferred method of forming the shell 202 of the bottle 201, the neck panels 304, 306, 307, 308, 310, 311 are pressed in a direction towards the longitudinal axis 214. As the neck panels 304, 306, 307, 308, 310, 311 are pressed inwardly, the curved edge of the lobe portion 360 of each of the neck panels 304, 306, 307, 308, 310, 311 allows a small rotation or bending of each of the neck panels 304, 306, 307, 308, 310, 311 about an axis transverse to the longitudinal axis. This rotation or bending results in the distal end edges 316 aligning to form a planar upper edge of the side wall 206.

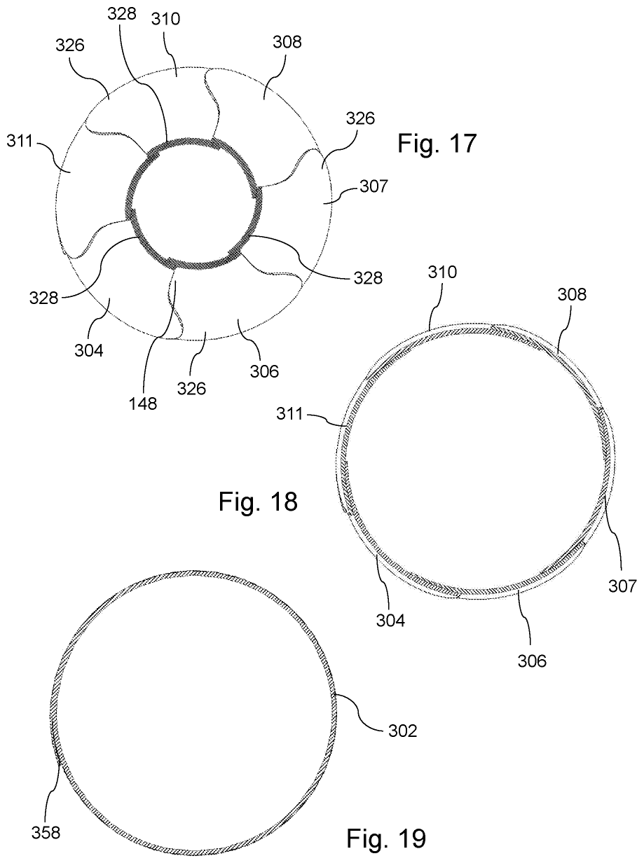

The distal portions 328 of the neck panels 304, 306, 307, 308, 310, 311 are each formed into a part-cylindrical shape (i.e. with a single axis of curvature) having a longitudinal axis aligned with the longitudinal axis of the shell 202 to form the neck portion 210 of the shell 202. An edge region adjacent the first side edge 312 of each of the neck panels 304, 306, 307, 308, 310, 311 overlaps or overlies an edge region adjacent the second side edge 314 of a neighbouring neck panel 304, 306, 307, 308, 310, 311, as shown in FIG. 17. These overlapping edge regions are adhered together to form the complete tubular neck portion 210 of the shell 202.

In a preferred method, neighbouring neck panels 304, 306, 307, 308, 310, 311 are pressed sequentially inwardly towards the longitudinal axis of the shell 202. The neck panels 304, 306, 307, 308, 310, 311 are pressed inwardly in order around the circumference of the bottle so that a first side edge region of a neck panel being pressed lies over and covers the adjacent second side of the previously pressed neck panel.

In this example, as the distal portions 328 of the neck panels 306, 310 are pressed to form the neck portion 210, the lugs 205 of the fitment 204 protrude through the apertures 334. It will be appreciated that the engagement of the lugs 205 in the apertures 334 helps to suspend the bag within the shell 202, and prevents the fitment 204 turning within the neck portion 210 of the shell 202. This prevents the fitment 204 turning when a user removes the screw cap 218 from the fitment 204 or secures the screw cap 218 onto the fitment 204.

The proximal portions 326 of the neck panels 304, 306, 307, 308, 310, 311 are each curved to form a part of the shoulder portion 216. In this embodiment each part of the shoulder portion 216 formed by a proximal portion 326 of the neck panels 304, 306, 307, 308, 310, 311 has a double curvature. In particular, each part of the shoulder portion 216 has two planes of principle curvature substantially perpendicular to each other. A first axis of curvature is substantially vertical and a second axis of curvature is substantially horizontal (relative to the longitudinal axis of the bottle 201). In this way, each part of the shoulder portion 216 has a part-dome shape or truncated part-dome shape.

The lobe portion 360 of each of the neck panels 304, 306, 307, 308, 310, 311 overlaps or overlies an edge region of the proximal portion 326 of a neighbouring neck panel 304, 306, 307, 308, 310, 311, as shown in FIG. 18. The overlapping lobe portions 360 and edge regions are adhered together to form the shoulder portion 216 of the shell 202.

Once the complete side wall 206 of the shell 202 has been formed, the base element 220 may be inserted into a lower end of the tubular side wall 206 and adhered to the side wall 206. Further, a label or strip of tape 226 may be wrapped around the neck portion 210 of the shell 202 to cover the overlapping edge regions of the distal portions 328 of the neck panels 304, 306, 307, 308, 310, 311 and to ensure that the neck portion 210 of the shell is secured around the lower end of the fitment 204. In particular, the label or strip of tape 226 may cover the lugs 205 of the fitment 204 that protrude through the apertures 334 in the neck panels of the second pair of neck panels 306, 310.

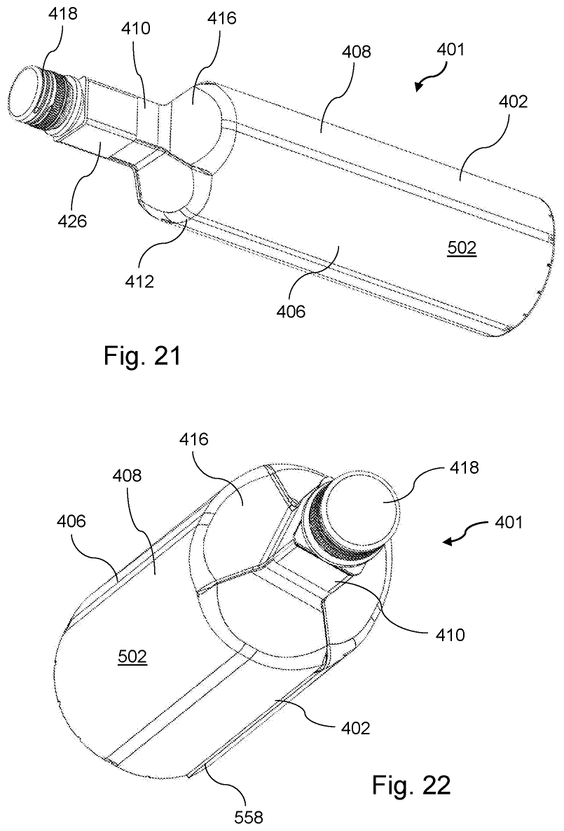

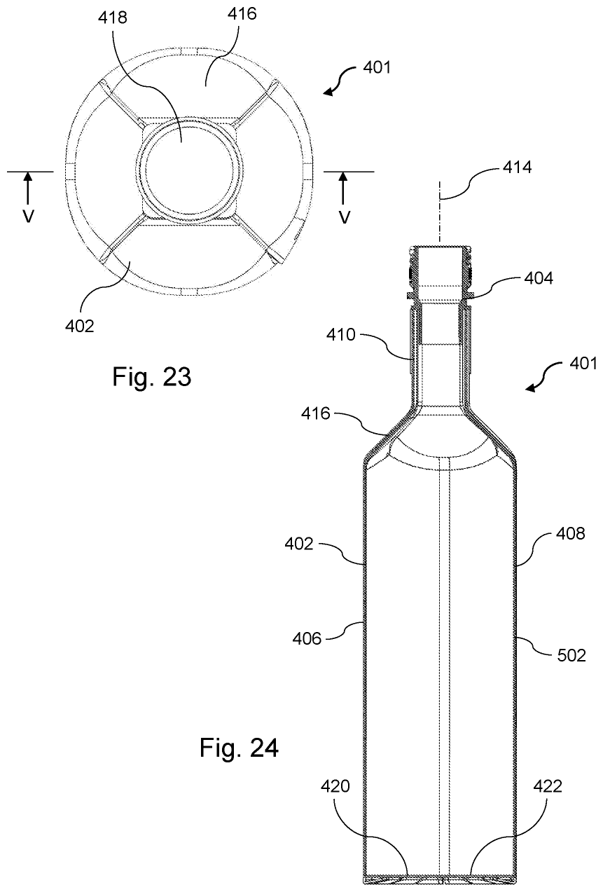

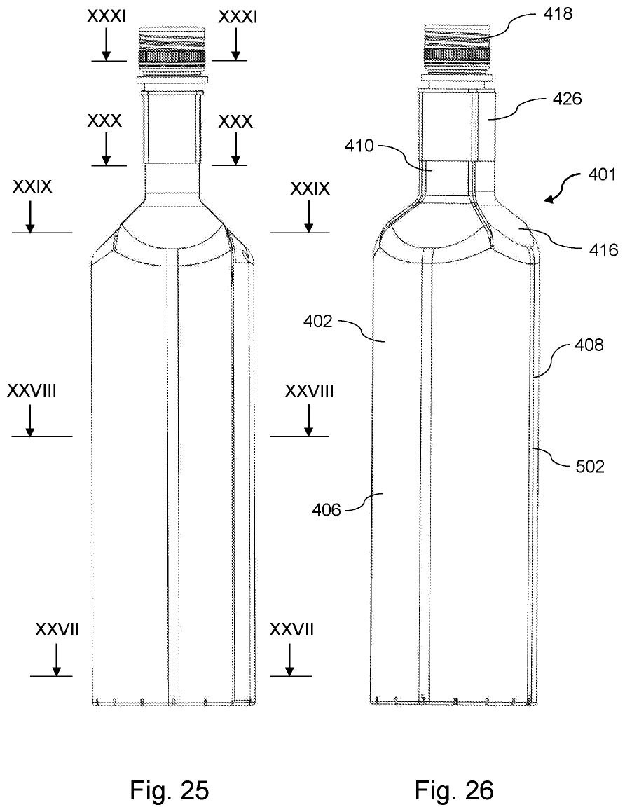

FIGS. 21 to 31 illustrate a container 401 in the form of a bottle 401. The bottle 401 comprises an outer shell 402 made of a paperboard or cardboard material and an inner vessel for holding a liquid. The inner vessel preferably comprises a bag (not shown) attached to a fitment 404. The bag is preferably adhered or welded to a lower portion of the fitment 404 so that the fitment 404 forms a neck portion of the inner vessel and defines an opening of the vessel. The bag and fitment 404 are, preferably, each made of a liquid impermeable material. The bag and fitment 404 may be made of a plastics material. The inner vessel is supported within the shell 402. In preferred embodiments the shell 402 completely surrounds the bag. The inner vessel is preferably supported within the shell 402 by the fitment 404.

In this example the shell 402 of the bottle 401 comprises a side wall 406 includes an elongate, tubular main body portion 408 and an elongate, tubular neck portion 410. The neck portion 410 extends from a first end 412 of the main body portion 408, and in this example a longitudinal axis 414 of the neck portion 410 is coaxial with a longitudinal axis 414 of the main body portion 408. This axis 414 forms a longitudinal axis of the complete bottle 401. A tapered, shoulder portion 416 of the bottle 401 extends between the neck portion 410 and the main body portion 408.

The fitment 404 is engaged with the neck portion 410 of the side wall 406 of the shell 402 such that the bag is suspended from the fitment 404 and extends into an internal volume defined and surrounded by the main body portion 408 of the side wall 406. It will be appreciated that the bag is preferably made of a flexible material. When the bag is filled with a liquid the bag may conform to at least part of an internal shape of the shell 402. An upper portion of the fitment 404, furthest from the bag, protrudes from an end of the neck portion 410 of the shell 402. The upper portion of the fitment 404 may include a male screw thread on an external surface for receiving and engaging with a female screw thread of a bottle top or cap 418. In this example the lower portion of the fitment 404 has a generally square cross-sectional shape in a plane perpendicular to its longitudinal axis. The upper portion of the fitment 404, that provides the screw thread, preferably has a circular cross-sectional shape in a plane perpendicular to its longitudinal axis.

The shell 402 may also include a base element 420. In this example the base element 420 comprises a base plate 422 engaged with the tubular main body portion 408 of the side wall 406 proximate a lower end of the side wall 406 furthest from the neck portion 410.

The side wall 406 of the shell 402 is preferably made from a flat sheet of paperboard that has been pressed to form the required three-dimensional shape of the bottle 401. In some examples the sheet of paperboard is multi-ply including a first surface layer formed from a paperboard material providing a good surface for printing. This first surface layer may comprise bleached fibres, for example. When the sheet of paperboard is pressed to form the side wall 406, the orientation of the paperboard is preferably such that this first surface layer forms an external surface 424 of the shell 402. Because the side wall 406 is formed from an initially flat sheet of paperboard, the first, outer surface of the paperboard may be easily printed before the side wall 406 is formed. This enables designs and branding to be applied to the container 401 before the shell 402 is formed, thereby decreasing the complexity and costs of applying designs to the container 401.

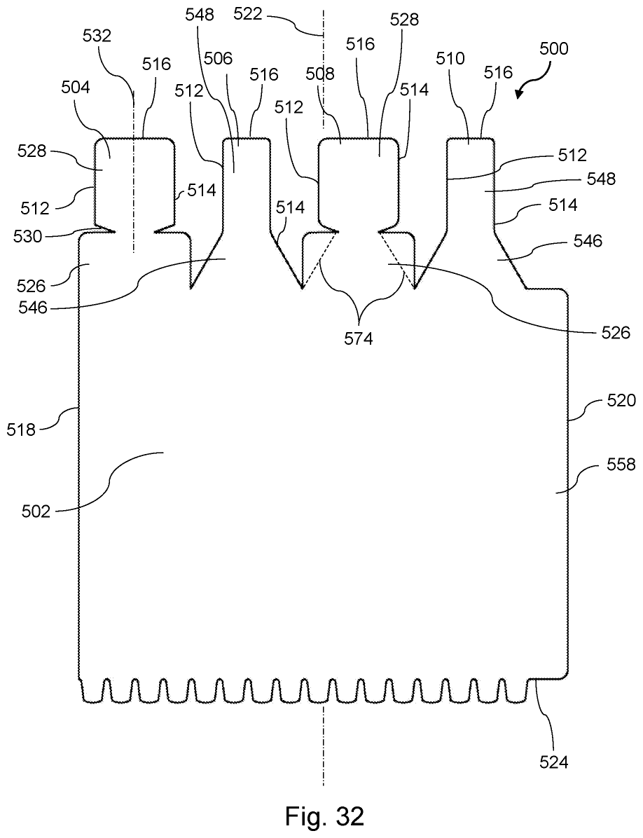

FIG. 32 illustrates a blank 500 used to form the side wall 406 of the shell 402 of the bottle 401. The blank 500 includes a substantially rectangular main body panel 502 and four neck panels 504, 506, 508, 510. The four neck panels 504, 506, 508, 510 extend from a first end of the main body panel 502. Each of the neck panels 504, 506, 508, 510 has first and second side edges 512, 514, and a distal end edge 516 furthest from the main body panel 502. Each of the neck panels 504, 506, 508, 510 extends from the main body panel 502 in a longitudinal direction.

Side edges 518, 520 of the main body panel 502 are parallel to each other. A line extending between the side edges 518, 520 defines a width or lateral direction of the main body panel 502, transverse to the longitudinal direction. A longitudinal axis 522 of the blank 500 extends in the longitudinal direction midway between the side edges 518, 520. The main body panel 502 also has a base end edge 524 furthest from the neck panels 504, 506, 508, 510 and extending between the side edges 518, 520.

In this example the blank 500 includes a first pair of neck panels 504, 508 and a second pair of neck panels 506, 510. The neck panels of the first pair of neck panels 504, 508 are identical in shape and configuration. Similarly, the neck panels of the second pair of neck panels 506, 510 are identical in shape and configuration. The neck panels of the first pair of neck panels 504, 508, however, have a different shape and configuration to that of the neck panels of the second pair of neck panels 506, 510. Each of the neck panels of the first pair of neck panels 504, 508 comprises a proximal portion 526 nearest the main body panel 502, and a distal portion 528 furthest from the main body panel 502 and adjacent the distal end edge 516 of the neck panel 504, 508. A smallest lateral or width dimension of each of the neck panels of the first pair of neck panels 504, 508 is disposed between the proximal portion 526 and the distal portion 528. This smallest lateral dimension defines a transition region 530 of each of the neck panels 504, 508 between the proximal portion 526 and the distal portion 528.

In the distal portion 528 of each of the neck panels of the first pair of neck panels 504, 508 the side edges 512, 514 are parallel to each other and extend generally in the longitudinal direction. At the transition region 530, the side edges 512, 514 extend laterally towards a centreline 532 of the neck panel 504, 508. In this way, the distal portion 528 of each of the neck panels 504, 508 has a generally rectangular shape. Similarly, in the proximal portion 526 of each of the neck panels of the first pair of neck panels 504, 508 the side edges 512, 514 are parallel to each other and extend generally in the longitudinal direction. At the transition region 530, the side edges 512, 514 extend laterally towards a centreline 532 of the neck panel 504, 508. In this way, the proximal portion 526 of each of the neck panels 504, 508 has a generally rectangular shape.

Each of the neck panels of the second pair of neck panels 506, 510 comprises a proximal portion 546 nearest the main body panel 502, and a distal portion 548 furthest from the main body panel 502 and adjacent the distal end edge 516 of the neck panel 506, 510.

In the distal portion 548 of each of the neck panels of the second pair of neck panels 506, 510 the side edges 512, 514 are parallel to each other and extend generally in the longitudinal direction. In this way, the distal portion 548 of each of the neck panels 506, 510 has a generally rectangular shape. A lateral dimension or width of the distal portion 548 of each of the neck panels of the second pair of neck panels 506, 510 is preferably approximately half the lateral dimension or width of the distal portion 528 of each of the neck panels of the first pair of neck panels 504, 508. Further, the lateral dimension or width of the distal portion 548 of each of the neck panels of the second pair of neck panels 506, 510 defines an external dimension of the neck portion 410 of the shell 402. In the proximal portion 546 of each of the neck panels of the second pair of neck panels 506, 510 the side edges 512, 514 diverge in a direction from the distal portion 548 towards the main body panel 502. An angle of divergence of the side edges 512, 514 in the proximal portion 546, measured relative to a centreline of the proximal portion 546, is preferably between 10° and 40°. In this way, the proximal portion 546 of each of the neck panels 506, 510 has a general trapezoidal shape.

An edge region 558 of the main body panel 502 adjacent the second side edge 520 provides a tab region 558. The tab region 558 preferably extends in the longitudinal direction along the full length of the side edge 520 of the main body panel 502. The tab region 558 extends in the lateral direction further than the maximum lateral extent of the neck panels 504, 506, 508, 510.

Referring again to FIGS. 21 to 31, the blank 500 is pressed to form the three-dimensional shape of the side wall 406 of the shell 402 of the bottle 401. The main body panel 502 is curved or bent to form the tubular main body portion 408 of the side wall 406. In this embodiment the main body panel 502 is curved around so that the tab region 558 overlaps an edge region of the main body panel 502 adjacent the other side edge 520. The tab region 558 is then adhered to the edge region to retain the tubular shape. With the blank 500 curved to the shape of the tubular main body portion 408 the neck panels of the first pair of neck panels 504, 508 are disposed diametrically opposite each other. Similarly, the neck panels of the second pair of neck panels 506, 510 are disposed diametrically opposite each other.

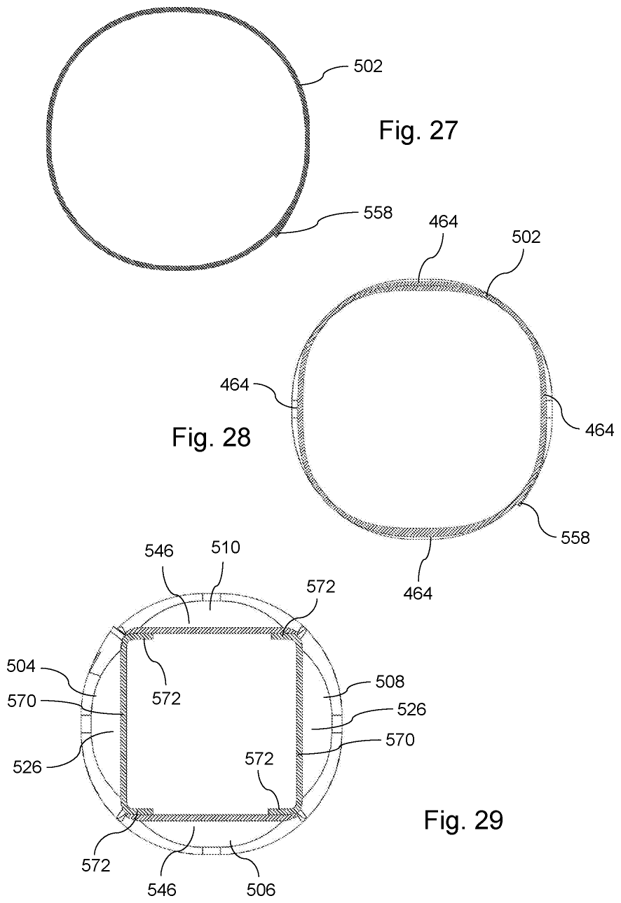

In this example a cross-sectional shape of the main body portion 408 of the side wall 406 in a plane perpendicular to the longitudinal axis 414 in a region proximate or adjacent the lower end of the side wall 406 is generally circular, as shown in FIG. 27. A cross-sectional shape of the main body portion 408 of the side wall 406 in a plane perpendicular to the longitudinal axis 414 in a region midway between the lower edge and the upper edge of the side wall 406 is generally square with rounded corners (squircle), as shown in FIG. 28. In this way, four generally planar primary faces 464 of the side wall 406 are formed, each of the primary faces 464 being aligned with one of the neck panels 504, 506, 508, 510.

The neck panels 504, 506, 508, 510 are then pressed around a suitable former to form the shoulder portion 416 and the tubular neck portion 410 of the shell 402. In particular, in this example, the proximal portions 526, 546 of the neck panels 504, 506, 508, 510 are shaped to form the shoulder portion 416 and the distal portions 528, 548 of the neck panels 504, 506, 508, 510 are shaped to form the neck portion 410 of the shell 402.

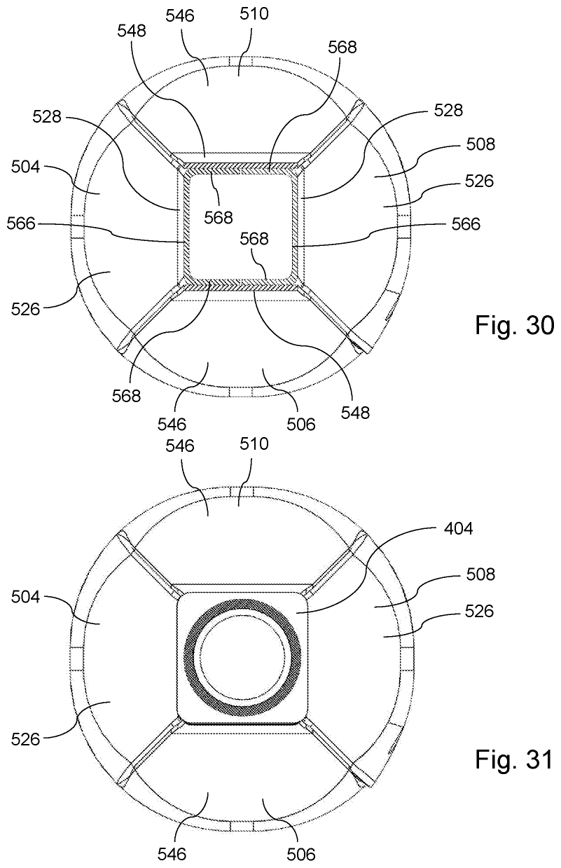

In a preferred method of forming the shell 402 of the bottle 401, the neck panels of the first pair of neck panels 504, 508 are pressed in a direction towards the longitudinal axis 414. The distal portions 528 of the neck panels 504, 508 are each formed into a U-shape having a central planar portion 566 and two planar wing portions 568 extending from either side of the central portion 566 in a direction generally transverse to the central portion 566. With the distal portions 528 of both of the neck panels 504, 508 formed in this way, respective and opposing side edges 512, 514 of the distal portions 528 preferably lie adjacent each other, and may be in contact with each other, as shown most clearly in FIG. 30.

The proximal portions 526 of the neck panels 504, 508 are pressed to form a part of the shoulder portion 416. In this embodiment each of the proximal portions 526 are pressed to form a central planar region 570 and two planar wing regions 572 extending from either side of the central region 570. The two planar wing regions 572 each extend in generally the same direction and in a direction transverse to the central region 570, as shown in FIG. 29. A fold line 574 between the central planar region 570 and a first one of the two planar wing regions 572 extends from a proximal end of the first side edge 512 to the side edge 512 in the transition region 530. Similarly, a fold line 574 between the central planar region 570 and a second one of the two planar wing regions 572 extends from a proximal end of the second side edge 514 to the side edge 514 in the transition region 530. Each of the fold lines 574 is preferably straight. In this way, a width of the central planar region 570 decreases in a direction from the main body panel 502 to the transition region 530, and a width of each of the two planar wing regions 572 increases in a direction from the main body panel 502 to the transition region 530.

The neck panels of the second pair of neck panels 506, 510 are then pressed in a direction towards the longitudinal axis 414. The distal portions 548 of the neck panels 506, 510 remain flat and are brought into contact with and adhered to an external surface of the wing portions 568 to form the neck portion 410 of the shell 402, as shown in FIG. 30. The proximal portions 546 of the neck panels 506, 510 also remain flat and are brought into contact with and adhered to an external surface of the wing regions 572 to form the shoulder portion 416 of the shell 402, as shown in FIG. 29. An external perimeter shape of each of the shoulder portion 416 and neck portion 410 of the shell 402 is therefore generally square.

Once the complete side wall 406 of the shell 402 has been formed, the base element 420 may be inserted into a lower end of the tubular side wall 406 and adhered to the side wall 406. Further, a label or strip of tape 426 may be wrapped around the neck portion 410 of the shell 402 to cover the overlapping regions of the distal portions 528, 548 of the neck panels 504, 506, 508, 510 and to ensure that the neck portion 410 of the shell is secured around the lower end of the fitment 404.

As described above, each of the shells 2, 202, 402 is formed by forming a flat blank 100, 300, 500 into the 3-dimensional shape of the shell 2, 202, 402. Overlapping edges of the blank 100, 300, 500 are adhered together, preferably using a suitable adhesive applied to surfaces of the blank 100, 300, 500. In preferred embodiments the adhesive is applied to regions of the blank 100, 300, 500 before forming the shell 2, 202, 402. The adhesive is, preferably, a heat activated or hot melt adhesive. In this way, the required region of the adhesive may be reactivated by the application of heat to the blank 100, 300, 500 when that part of the shell 2, 202, 402 is being formed.

It will be appreciated that the three examples described above are exemplary only and other blanks may be used to form similar bottles. In particular, the blank 100 of the first example may be varied to have more than four neck panels. The blank may, for example, have six neck panels, with a third pair of neck panels being similar in shape and configuration to the second pair of neck panels 106, 110 of the first example. The blank 300 of the second example (embodiment of the invention) may be varied to have more than six neck panels. The blank may, for example, have eight or ten neck panels, with further pairs of neck panels being similar in shape and configuration to the first and third pairs of neck panels 304, 308, 307, 311 of this embodiment. The blank 500 of the third example may be varied to have six or eight neck panels. The shape of each of the neck panels would then be such that the resultant shell would have a hexagonal or octagonal cross-sectional shape perpendicular to a longitudinal axis of the bottle.

Although in two of the above examples an aperture was provided in a pair of neck panels of the blank, it will be appreciated that in other examples and/or embodiments the aperture may not be formed as illustrated by punching or cutting a hole in the distal portions of the neck panels. In other examples and/or embodiments of the blank an aperture may effectively be formed by making one or more slits or cuts in the distal portion of the neck panel. In these embodiments, the slit(s) or cut(s) are formed and positioned so that when the neck panel is brought into contact with the lugs of the fitment, the lugs push through the slit(s) or cut(s) thereby deforming a region of the distal portion around the slit(s) or cut(s).

In yet further examples and/or embodiments the distal region of the neck panel may include a weakened region. This weakened region may be defined by a line of perforations or an impressed line (i.e. thinner line of material) extending around a perimeter of the region. When used to form the side wall of the shell, the weakened region may be pushed or pressed out by contact with the lugs of the fitment. This weakened region may be referred to as a chad.

In the embodiment described above, the blank 300 is designed to form the complete side wall 206 of the shell 202. In other embodiments the side wall 206 may be formed from two blanks, each blank being similar in design and configuration to half of the illustrated blank 300. For example each blank may be used to form a semi-cylindrical part of the side wall of the shell. Each blank may only include two or three neck panels, so that the complete shell includes four or six neck panels, respectively.

It will be appreciated that a bottle having sequentially overlapping neck panels may have a cross-sectional shape perpendicular to the longitudinal axis of the shell that is not circular. For example, the main body portion of the blank may be pressed and formed into a hexagonal or octagonal shape and the neck panels may also be pressed to form a corresponding hexagonal or octagonal shape. The bottle may have a polygonal cross-sectional shape having any number of sides or faces, for example, between three and twenty sides.

References to the tubular main body portion having a first, larger diameter and the tubular neck portion having a second, smaller diameter, should be understood, in relation to bottles having a non-circular cross-sectional shape, as references to the main body portion having a larger dimension in a direction perpendicular to the longitudinal axis (or a larger equivalent diameter) and the tubular neck portion having a smaller dimension in a direction perpendicular to the longitudinal axis (or a smaller equivalent diameter). A radial direction or width direction is defined perpendicular to the longitudinal axis of the bottle or shell. The neck portion may therefore be defined as having a smaller maximum radial dimension than a maximum radial dimension of the main body portion.

Other modifications and variations not explicitly disclosed above may also be contemplated without departing from the scope of the invention as defined in the appended claims.

1-23. (canceled)

24. A bottle having a shell made from a flat blank of paperboard material that has been pressed to form the three-dimensional shape of the bottle and an inner vessel for holding a liquid, the inner vessel being supported by and surrounded by the shell, the shell providing a tubular side wall of the bottle including a main body portion and a neck portion, the neck portion having a smaller diameter than the main body portion, and the neck portion comprising at least four overlapping neck panels of the blank of paperboard material, the blank of paperboard material comprising a main body panel forming the main body portion of the side wall and the neck panels extending from the main body panel, each of the neck panels including a proximal portion, a distal portion, and side edges defining a width of the neck panel, wherein at least a first side edge of all of the neck panels has an identical perimeter shape in the distal portion.

25. The bottle of claim 24, in which each of the neck panels has a first side edge and a second side edge and a lateral extent of the side edges of each neck panel is a distance of the side edge from a centreline of the neck panel in a direction perpendicular to the centreline, and wherein in the blank of paperboard material prior to forming the shell a maximum lateral extent of the first side edge of each neck panel does not extend further than a maximum lateral extent of the second side edge of an adjacent neck panel.

26. The bottle of claim 24, in which a smallest width dimension of each of the neck panels is between the proximal portion and the distal portion.

27. The bottle of claim 24, in which the neck portion comprises at least four sequentially overlapping neck panels of the blank of paperboard material, each of said neck panels having a first side edge and a second side edge, and edge regions adjacent the first side edge of each of the neck panels overlying an edge region adjacent the second side edge of a neighbouring neck panel.

28. The bottle of claim 24, in which two diametrically opposite neck panels each include an aperture or region with which the inner vessel is engaged.

29. The bottle of claim 24, in which the tubular side wall of the bottle is made from a single flat sheet of paperboard material.

30. The bottle of claim 24, in which each neck panel includes a distal end edge, and wherein in the blank of paperboard material prior to forming the shell each of the distal end edges are parallel to each other and not perpendicular to the side edges of the main body panel.

31. The bottle of claim 24, wherein in the blank of paperboard material prior to forming the shell the first side edge in the proximal portion of all but one of the neck panels is coincident with the second side edge in the proximal portion of a neighbouring one of the neck panels.

32. The bottle of claim 24, in which the first side edge in the proximal portion of each of the neck panels has a convex curvature.

33. The bottle of claim 24, in which a proximal end of the first side edge of each neck panel is disposed at or proximate a centreline of the respective neck panel.

34. The bottle of claim 24, in which the inner vessel comprises a fitment and a bag for holding a liquid, and wherein the fitment is engaged with the neck portion of the side wall such that the bag is suspended from the fitment and extends into an internal volume defined and surrounded by the main body portion of the side wall, and wherein an upper end of the fitment, furthest from the bag, protrudes from an end of the neck portion of the side wall.

35. The bottle of claim 24, in which the neck panels comprise a first pair of neck panels and a second pair of neck panels, the neck panels of the first pair of neck panels are identical in shape and configuration, and the neck panels of the second pair of neck panels are identical in shape and configuration, the neck panels of the first pair of neck panels have a different shape and configuration to that of the neck panels of the second pair of neck panels, and the neck panels are arranged such that a first one of the neck panels of the second pair of neck panels is disposed between the neck panels of the first pair of neck panels, and a second one of the neck panels of the first pair of neck panels is disposed between the neck panels of the second pair of neck panels.

36. A method of forming a bottle according to claim 24, comprising:
providing a blank formed of a flat sheet of paperboard, the blank comprising a main body panel having two opposite side edges, a line between the side edges defining a width direction of the main body panel, and at least four neck panels extending from the main body panel in a direction transverse to the width direction, each of the neck panels including a proximal portion, a distal portion, and side edges defining a width of the neck panel, wherein at least a first side edge of all of the neck panels has an identical perimeter shape in the distal portion;
bending the blank about a longitudinal axis transverse to the width direction;
adhering a first edge region of the main body panel adjacent a first one of the side edges to a second edge region of the main body panel adjacent a second one of the side edges to form a tubular side wall of the bottle about the longitudinal axis;
pressing the neck panels of the blank in a direction towards the longitudinal axis so that the neck panels overlap; and
adhering neighbouring neck panels to each other.

37. The method of claim 36, in which the step of pressing the neck panels comprises pressing the neck panels of the blank in a direction towards the longitudinal axis so that a first side edge of each neck panel overlies a second side edge of a neighbouring neck panel to form a neck section of the bottle having sequentially overlapping panels.

38. The method of claim 36, in which each neck panel of the blank includes a distal end edge, and the distal end edges are parallel to each other and not perpendicular to the side edges of the main body panel, and wherein during pressing of the neck panels each of the neck panels rotates until the distal end edges align to form a planar upper edge of the side wall of the shell.

39. The method of claim 36, further comprising:
engaging a base element with an end of the tubular side wall furthest from the neck panels; and
attaching the base element to the tubular side wall.

40. The method of claim 36, further comprising:
before pressing the neck panels, positioning an inner vessel inside an internal volume defined by the tubular side wall and then pressing the neck panels to engage the neck panels with a part of the inner vessel, the inner vessel having an internal volume for holding a liquid.

41. The method of claim 40, in which the inner vessel includes a fitment and a flexible bag, and wherein the method comprises engaging the fitment with at least two of the neck panels to prevent rotation of the fitment with respect to the shell about a longitudinal axis of the bottle.

42. The method of claim 41, in which two diametrically opposite neck panels include apertures and the step of engaging the fitment with at least two of the neck panels comprises engaging a pair of lugs of the fitment with the apertures.

43. The method of claim 36, further comprising printing a first, outer surface of the paperboard blank before the tubular side wall is formed.
